(19) United States
(12) Patent Application Publication
(10) Pub. No.: US 2026/0056102 A1
(43) Pub. Date: Feb. 26, 2026

(54) METHOD FOR EVALUATING STIFFNESS OF RAILWAY BALLASTED TRACKS

(71) Applicants: RAILWAY ENGINEERING RESEARCH INSTITUTE, CHINA ACADEMY OF RAILWAY SCIENCES CORPORATION LIMITED, Beijing (CN); CHINA ACADEMY OF RAILWAY SCIENCES CORPORATION LIMITED, Beijing (CN)

(72) Inventors: YANG XU, Beijing (CN); LUCHAO QIE, Beijing (CN); HONGYANG HAN, Beijing (CN); YI LI, Beijing (CN); WENYING YU, Beijing (CN); YINGHUI TU, Beijing (CN); CHEN LIANG, Beijing (CN); LEI ZHAO, Beijing (CN); HAO ZUO, Beijing (CN)

(21) Appl. No.: 18/865,342

(22) PCT Filed: Apr. 1, 2023
(86) PCT No.: PCT/CN2024/085175

§ 371 Date: Nov. 13, 2024

(30) Foreign Application Priority Data
Feb. 6, 2023 (CN) 202310063881.0

(51) Int. Cl. G01N 3/303

(52) U.S. Cl. CPC G01N 3/303

(57) ABSTRACT

A method for evaluating stiffness of railway ballasted tracks is provided. The method includes the steps of: performing an indoor test to measure stiffness of a standard ballast bed block and plotting a load-displacement curve of the standard ballast bed block; fitting a relationship function between the stiffness of the standard ballast bed block and test scalar; using the relationship function to obtain a stiffness evaluation standard based on the test scalar; conducting a drop-weight test on a track and calculating actual test scalar of the track based on results of the drop-weight test; and evaluating stiffness conditions of the track based on the actual test scalar of the track and the stiffness evaluation standard. The present invention aims to enable rapid and efficient evaluation of not only the ballast bed stiffness, but also entire track system stiffness.

### CROSS-REFERENCE TO RELATED APPLICATION

This application is a national stage application of International Application No. PCT/CN2024/085175, filed on Apr. 1, 2023, which claims priority to Chinese Patent Application No. 202310063881.0, filed on Feb. 6, 2023. The disclosures of the aforementioned applications are hereby incorporated by reference in their entireties.

### FIELD OF THE INVENTION

The present disclosure relates to the field of stiffness analysis of ballasted tracks, more particularly to a method for evaluating stiffness of railway ballasted tracks.

### BACKGROUND OF THE INVENTION

Ballasted tracks are the most common form of railway lines in China. Support stiffness of a ballast bed is a key indicator that reflects service condition of the track and ensures safe and smooth operation of the train. Poor local support of the ballast bed may cause issues such as sleeper suspension, twist and warp. Traditional methods for testing the ballast bed stiffness mainly have following drawbacks: (1) some testing methods require removal of fastening plates and use of hydraulic jacks and displacement meters to measure force-displacement curves, which are time-consuming, labor-intensive, inefficient, and inaccurate, and provide only static stiffness that differs significantly from dynamic stiffness under train loads, failing to reflect the true mechanical state of the ballast bed; (2) Chinese patent application CN103774512A discloses the equipment using drop hammer impact to dynamically test the support stiffness of the ballast bed, which merely replaces the traditional static loading of the hydraulic jacks with dynamic loading of the drop hammer, still involving large amounts of calculation and low efficiency, and being unsuitable for rapidly evaluating stiffness of a large number of tracks in the field; (3) some testing methods can only calculate the ballast bed stiffness through experiments and lack a reasonable evaluation standard; (4) some testing methods are limited to testing ballast bed stiffness and cannot be used to test and evaluate entire system stiffness, including rails, fasteners, and ballast bed.

### BRIEF SUMMARY OF THE INVENTION

The present invention provides a method for evaluating stiffness of railway ballasted tracks to solve the problem that the prior art can only test the ballast bed stiffness, along with the excessive calculations and inefficiencies, aiming to enable rapid and efficient evaluation of not only the ballast bed stiffness, but also entire track system stiffness.

The present invention is achieved through the following technical solution:

A method for evaluating stiffness of railway ballasted tracks is provided. The method includes the steps of:
performing an indoor test to measure stiffness of a standard ballast bed block and plotting a load-displacement curve of the standard ballast bed block;
fitting, based on the load-displacement curve, a relationship function between the stiffness of the standard ballast bed block and test scalar;
using the relationship function to obtain a stiffness evaluation standard based on the test scalar;
conducting a drop-weight test on a track and calculating an actual test scalar of the track based on results of the drop-weight test; and
evaluating stiffness conditions of the track based on the actual test scalar of the track and the stiffness evaluation standard.

The present invention provides the method for the evaluating stiffness of railway ballasted tracks to address the problems in the prior art, where stiffness tests can only test ballast bed support, and testing process involves significant calculations and inefficiencies. Such method first performs an indoor test to measure stiffness of a standard ballast bed block, and obtain a load-displacement curve of the standard ballast bed block, wherein the indoor test refers to the existing stiffness testing methods used in a laboratory setting. Next, based on the obtained load-displacement curve, a relationship function is fitted, which is required to reflect the correlation between ballast stiffness and test scalar, wherein the test scalar refers to a parameter correlated with ballast stiffness, so as to obtain the relationship function. The specific selection of the test scalar is not limited here. Then, a stiffness evaluation standard based on the test scalar is obtained according to the relationship function. So far, the preparatory phase before the field test and evaluation is completed. In the present invention, the field test involves conducting a drop-weight test on a track in the field, calculating an actual test scalar of the track according to the drop-weight test results, and substituting the actual test scalar into the stiffness evaluation standard to obtain evaluation results of the stiffness conditions. The track of the present invention refers not only to the ballast bed support tested at ends of the sleepers, but also to the entire track system tested near the central section of the sleepers, wherein the entire track system includes rails, fasteners, and ballast bed.

The method provided in the present invention introduces the test scalar to establish a correlation between the test scalar and the ballast bed stiffness, allowing for effective stiffness evaluation of the tested track by simply calculating its actual test scalar. Such method overcomes the shortcomings of the prior art that needs to conduct field tests for each track so as to obtain the stiffness of the tested track through extensive calculation. Also, the method significantly reduces computational load for track stiffness analysis and improves evaluation efficiency, having significant engineering application value for mass evaluation of the track stiffness. In addition, the present invention creatively proposes a method for obtaining a stiffness evaluation standard for ballasted tracks based on the test scalar, filling a gap in the prior art. Furthermore, such method can evaluate both ballast bed stiffness and the entire track system stiffness, including rails, fasteners, and ballast, greatly expanding its scope of application compared with the existing methods that can merely evaluate the support stiffness of the ballast bed.

In some embodiments, the standard ballast bed block is a polyurethane-cured ballast bed block, which has low production error, improving the precision of the indoor test and thereby increasing the calibration accuracy of the test scalar.

In some embodiments, the method for fitting the relationship function further includes the steps of:
selecting three characteristic points on the load-displacement curve and calculating tangent slope of the load-displacement curve at each of the three characteristic points; and
using a cubic function to fit the tangent slope, with the test scalar as an independent variable and the stiffness of the standard ballast bed block as a dependent variable, to obtain the relationship function.

The aforementioned scheme proposes a specific method for fitting the relationship function, which uses the tangent slope of the load-displacement curve at the three characteristic points as the test scalar to fit the relationship function. The inventor has found through experiments that the relationship function derived from this method can fully characterizes the relationship between the test scalar and stiffness, and the average error rate is less than 5%, allowing for direct estimation of actual stiffness values in practical engineering applications based on the test scalar, thus avoiding the need for extensive and cumbersome calculations to obtain actual stiffness. In one or more embodiments, the characteristic points are selected from the points that can represent the basic trend of the load-displacement curve, for example, the inflection points, and/or the points on smoothly extending section of the load-displacement curve.

Furthermore, the three characteristic points are points on the load-displacement curve corresponding to loads being 25%, 50% and 75% of measured wheel-rail force on the tested track. The inventor's experiment has confirmed that the three characteristic points selected by this method can effectively present the trend of the load-displacement curve.

In some embodiments, the cubic function is: kᵣ=ak³+bk²+ck+d, where kᵣ is the stiffness of the standard ballast bed block, k is the test scalar, and a, b, c, d are calibration coefficients. The calibration coefficients can be determined by substituting the tangent slope of the three characteristic points into the cubic function.

In some embodiments, the method for obtaining the stiffness evaluation standard based on the test scalar further includes the steps of:
establishing a local track spring constitutive model and obtaining a dynamic displacement calculation formula comprising a plurality of variables;
conducting a plurality of on-site stiffness tests on a ballast bed by using standard testing methods to obtain values of the variables;
determining critical conditions for dynamic displacement;
obtaining ballast bed stiffness under the critical conditions by substituting the values of the variables and the critical conditions into the dynamic displacement calculation formula;
obtaining the test scalar under the critical conditions by substituting the ballast bed stiffness under the critical conditions into the relationship function; and
establishing the stiffness evaluation standard based on the test scalar according to the test scalar under the critical conditions.

Such method first establishes the local track spring constitutive model and determines one or more variables except the stiffness value in the dynamic displacement calculation formula of the local track spring constitutive model. Then the standard testing methods are used to conduct on-site tests to obtain values of the corresponding variables. In this method, the standard testing methods can be any of the standard methods known to those skilled in the art, e.g., “Testing method of railway ballast bed parameters” specified in TB/T3448-2016. The number of the on-site stiffness tests for ballast bed conducted by the standard testing methods is not limited here, and those skilled in the art should appreciate that the more tests being conducted, the higher the accuracy of the obtained values of the variables.

Next, one or more critical conditions for the dynamic displacement can be determined. The critical conditions may include the maximum dynamic displacement value of the ballasted tracks obtained from relevant specifications or standards in railway field, and/or critical values of the dynamic displacement before the ballast bed changes its state. The test scalar under different critical conditions can be obtained by substituting the ballast bed stiffness under all the critical conditions into the aforementioned relationship function, thereby establishing the stiffness evaluation standard.

In some embodiments, the method for calculating the actual test scalar of the track based on the results of the drop-weight test further includes the steps of:
obtaining the results of the drop-weight test, wherein the results comprises impact force of a drop weight on the track, displacement of the track, and maximum displacement of the track during an impact process; and
substituting the results of the drop-weight test into a test scalar calculation formula to obtain the actual test scalar of the track.

In the present scheme, the impact force and the displacement can be respectively measured by pressure sensors and displacement sensors disposed in the bearing plate of a drop weight impact tester.

Furthermore, a method for establishing the test scalar calculation formula includes the steps of:
assuming the track as a series-connected spring system, and establishing a balance equation between gravity of a drop hammer and elastic force of a spring, wherein the balance equation is defined as Equation 1;
establishing a momentum equation for a falling process of the drop hammer, integrating over time on both sides of the momentum equation to obtain Equation 2;
establishing an energy conservation equation of a process from a first moment at which the drop hammer starts to fall to a second moment at which the track reaches maximum displacement, wherein the energy conservation equation is defined as Equation 3; and
solving the Equation 1, Equation 2, and Equation 3 together to obtain the test scalar calculation formula.

The test scalar is present in any one or more of the Equation 1, Equation 2 and Equation 3.

The method discloses details for establishing the test scalar calculation formula, wherein this method assumes the track as the series-connected spring system, and uses Newton's Third Law, theorem of momentum, and principle of conservation of energy to establish the formula, which is scientific and reasonable, ensuring fast and accurate calculation of the test scalar in practical engineering applications.

In some embodiments, the test scalar calculation formula is:

$$k = \frac{\begin{matrix}( 2 \int Fdt \int sdt + {{ms}_{0}}^{2} ) \pm \\ \sqrt{{( 2 \int Fdt \int sdt + {{ms}_{0}}^{2} )}^{2} - 4 {( \int sdt )}^{2} {( \int Fdt )}^{2}}\end{matrix}}{2 {( \int sdt )}^{2}}$$

where k is the test scalar, F is impact force of the drop weight on the track, s is the displacement of the track, s₀ is the maximum displacement of the track during the impact process, m is a mass of drop hammer, t is time, ∫Fdt is an integral of F over the time, and ∫sdt is an integral of s over the time.

Furthermore, in the drop-weight test, an impact kinetic energy of a drop hammer on the track ranges from 186.13 J to 201.13 J. The inventor found through extensive research that when the impact kinetic energy of the drop hammer falls within this range, the error rate of the fitted relationship function is relatively low. If the impact kinetic energy falls outside this range, it leads to an increase in error, and even exceeds acceptable engineering limits in severe cases. It should be noted that the specified range of 186.13 J to 201.13 J includes the endpoints of 186.13 J and 201.13 J.

As compared with the prior art, the embodiments provided in the present disclosure has the following advantages and beneficial effects:
1. The method provided in the present invention introduces the test scalar to establish a correlation between the test scalar and the ballast stiffness, allowing for effective stiffness evaluation of the tested track by simply calculating its actual test scalar, and overcoming the shortcomings of the prior art that needs to conduct field tests for each track so as to obtain the stiffness of the tested track through extensive calculation, thereby significantly reducing computational load for track stiffness analysis and improving evaluation efficiency, and having significant engineering application value for mass evaluation of the track stiffness.
2. The method provided in the present invention proposes a method for obtaining a stiffness evaluation standard for ballasted tracks based on the test scalar, filling a gap in the prior art.
3. The method provided in the present invention can evaluate both ballast bed stiffness and the entire track system stiffness, including rails, fasteners, and ballast, greatly expanding its scope of application compared with the existing methods that can merely evaluate the support stiffness of the ballast bed.
4. The present invention proposes a specific fitting method for the relationship function, which fully characterizes the relationship between the test scalar and stiffness, and the average error rate is less than 5%, allowing for direct estimation of actual stiffness values in practical engineering applications based on the test scalar, thus avoiding the need for extensive and cumbersome calculations to obtain actual stiffness.
5. The present invention calculates the test scalar of the track through the drop-weight test, ensuring rapid and accurate computation of the test scalar in practical engineering applications.

### BRIEF DESCRIPTION OF THE DRAWINGS

The present invention will become more readily apparent to those ordinarily skilled in the art after reviewing the following detailed description and accompanying drawings, in which:

FIG. 1 is a flowchart of a method for evaluating stiffness of railway ballasted tracks according to an embodiment of the present disclosure; and

FIG. 2 is a load-displacement curve diagram according to an embodiment of the present disclosure.

### DETAILED DESCRIPTION OF THE PREFERRED EMBODIMENTS

The present invention will now be described more specifically with reference to the following embodiments. It is to be noted that the following descriptions of preferred embodiments of this invention are presented herein for purpose of illustration and description only. It is not intended to be exhaustive or to be limited to the precise form disclosed. In the description of the present disclosure, it should be understood that terms for expressing direction such as front, rear, left, right, up, down, vertical, horizontal, high, low, inside, outside, etc. are used to explain the orientation or position with reference to the drawings, are intended merely to simplify the description of the present disclosure, rather than indicating or implying that the device or the element must be constructed or operated in such specific orientation or position, and therefore should not be construed as limiting the scope of the present disclosure.

### Embodiment 1

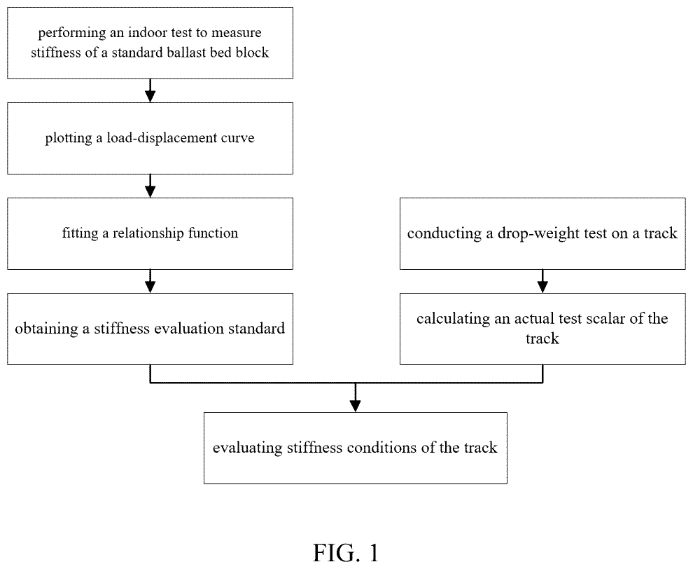

A method for evaluating stiffness of railway ballasted tracks, the process of which is shown in FIG. 1, mainly includes the steps of:
performing an indoor test to measure stiffness of a standard ballast bed block and plotting a load-displacement curve of the standard ballast bed block;
fitting, based on the load-displacement curve, a relationship function between the stiffness of the standard ballast bed block and test scalar;
using the relationship function to obtain a stiffness evaluation standard based on the test scalar;
conducting a drop-weight test on a track and calculating an actual test scalar of the track based on results of the drop-weight test; and
evaluating stiffness conditions of the track based on the actual test scalar of the track and the stiffness evaluation standard.

In this embodiment, the standard ballast bed block used in the indoor test is a polyurethane-cured ballast bed block prepared according to the specification of TJ/GW164-2020 “Provisional Technical Specification for Assembled Polyurethane Elastic Ballast Bed”.

### Embodiment 2

Based on Embodiment 1, the method for evaluating stiffness of railway ballasted tracks further express the relationship function between the stiffness of the standard ballast bed block and test scalar in the form of a cubic function: kᵣ=ak³+bk²+ck+d, wherein kᵣ is the stiffness of the standard ballast bed block, k is the test scalar, and a, b, c, d are calibration coefficients. The method for fitting the relationship function includes following steps:

Selecting three characteristic points on the load-displacement curve and calculating tangent slope of the load-displacement curve at each of the three characteristic points; using the test scalar as an independent variable and the measured stiffness of the standard ballast bed block as a dependent variable; and substituting the measured stiffness as the kᵣ in the cubic function, and the tangent slope at each of the three characteristic points as the k in the cubic function to calculate the values of calibration coefficients a, b, c, and d, completing the fitting of the cubic function so as to obtain the required relationship function.

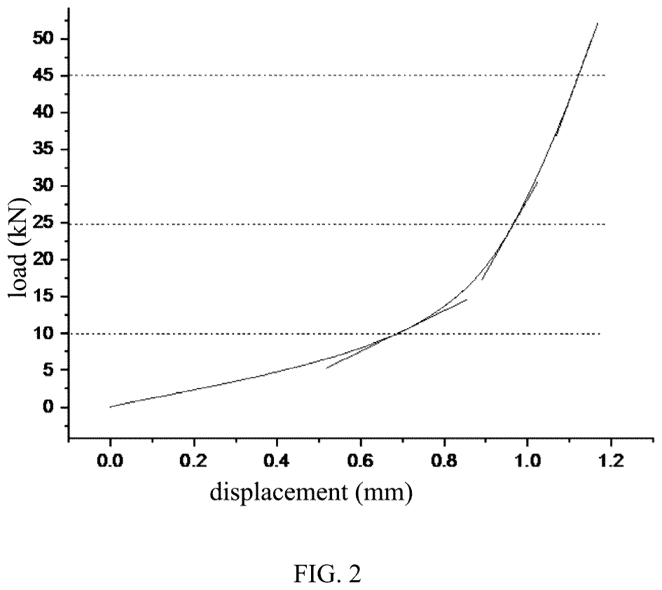

The load-displacement curve obtained in Embodiment 2 is shown in FIG. 2. As shown in FIG. 2, the load-displacement curve can be divided, according to its trend from left to right, into three sections: a slowly rising section, a curved transition section, and a rapidly rising section. Thus, in this embodiment, the inflection point between the slowly rising section and the curved transition section, the inflection point between the curved transition section and the rapidly rising section, and one random point in the rapidly rising section are selected as the tree characteristic points. The corresponding loads for the selected three characteristic points are 10 kN, 26 kN, and 45 kN, respectively. FIG. 2 shows the tangents corresponding to each of the three characteristic points, from which the tangent slope can be calculated.

Apart from the method of selecting three characteristic points as shown in FIG. 2, in some embodiments, one random point from the slowly rising section, the inflection point between the slowly rising section and the curved transition section, and the inflection point between the curved transition section and the rapidly rising section can be selected as the three characteristic points.

In a more preferred embodiment, the three characteristic points are points on the load-displacement curve corresponding to loads being 25%, 50%, and 75% of a measured wheel-rail force on the tested operational line.

### Embodiment 3

Based on any of the above embodiments, the method for evaluating stiffness of railway ballasted tracks further obtains a stiffness evaluation standard based on the test scalar through the steps of:
establishing a local track spring constitutive model and obtaining the following dynamic displacement calculation formula:

$$S = \frac{F ( {k}_{f} + {k}_{r} )}{{k}_{f} \times {k}_{r}}$$

wherein S is the dynamic displacement, k_{f} is the stiffness of the fastening plate, kr is the stiffness of the standard ballast bed block, and F is the product of the wheel-rail force corresponding to a single sleeper and a safety factor.

In the dynamic displacement calculation formula, kr and F are variables.

The values of the variables can be obtained by conducting a plurality of on-site stiffness tests for ballast bed with standard testing methods. Specifically, this embodiment conducted on-site stiffness on the ballast bed according to specification of TB/T3448-2016 “Testing method of railway ballast bed parameters”. Since the stiffness of ballasted track is quite discrete, this embodiment measured more than 100 sets of data, and determined that k_{f} is 60 and F is 68 KN.

Next, the critical condition for the dynamic displacement is established, referring to “Technical regulation for dynamic acceptance for high-speed railways construction”, that the allowable limit for dynamic displacement of ballasted tracks is set at 2.5 mm. Thus, the allowable limit is substituted into the dynamic displacement calculation formula to determine that kᵣ<50 does not meet the requirement of the technical regulation, and the sleeper is deemed to be suspended.

Then, under premise of kᵣ≥50, ballast bed conditions are classified according to different stiffness values of the standard ballast bed block, and a stiffness evaluation standard based on kᵣ is ultimately obtained as shown in Table 1.

TABLE 1
Stiffness Evaluation Standard Based on kᵣ

| ballast bed condition | kr(kN/mm) |
|---|---|
| sleeper suspended | kᵣ < 50 |
| generally supported | 50 ≤ kᵣ ≤ 70 |
| well supported | 70 < kᵣ ≤ 130 |
| rigid supported | 130 < kᵣ |

In this embodiment, the kᵣ values in Table 1 can also be substituted into the relationship function kᵣ=ak³+bk²+ck+d fitted in Embodiment 2. Specifically, each kᵣ in Table 1 is converted into the test scalar k to establish a stiffness evaluation standard based on the test scalar.

### Embodiment 4

Based on any of the above embodiments, the drop-weight test in this embodiment is conducted by using equipments comprising a controller, a drop hammer, a guide rod, a spring damper, and a bearing plate. In the drop-weight test, the bearing plate is first placed directly on the sleeper or the rail, the falling hammer is then released by the controller to impact, and the impact force and displacement experienced during the impact are captured by the sensors disposed in the bearing plate. The equipments of the drop-weight test are positioned at the ends of the sleepers to evaluate the ballast bed stiffness. Also, the equipments of the drop-weight test can be positioned at the center of the rail to evaluate the entire rail system stiffness.

The present embodiment proposes a method for calculating the test scalar of the track, and the method includes the following steps:
assuming the track as a series-connected spring system, and establishing a balance equation between gravity of the drop hammer and elastic force of a spring, wherein the balance equation is defined as Equation 1;
establishing a momentum equation for a falling process of the drop hammer, integrating over time on both sides of the momentum equation to obtain Equation 2;
establishing an energy conservation equation of a process from a first moment at which the drop hammer starts to fall to a second moment at which the track reaches maximum displacement, wherein the energy conservation equation is defined as Equation 3; and
solving the Equation 1, Equation 2, and Equation 3 together to obtain the test scalar calculation formula.

The test scalar is present in any one or more of the Equation 1, Equation 2 and Equation 3.

Preferably, this embodiment takes the stiffness of the series-connected spring system as the test scalar k.

The test scalar calculation formula ultimately obtained in this embodiment is as follows:

$$k = \frac{\begin{matrix}( 2 \int Fdt \int sdt + {{ms}_{0}}^{2} ) \pm \\ \sqrt{{( 2 \int Fdt \int sdt + {{ms}_{0}}^{2} )}^{2} - 4 {( \int sdt )}^{2} {( \int Fdt )}^{2}}\end{matrix}}{2 {( \int sdt )}^{2}}$$

where k is the test scalar, F is impact force of the drop weight on the track, s is the displacement of the track, so is the maximum displacement of the track during the impact process, m is a mass of a drop hammer, t is time, ∫Fdt is an integral of F over the time, and ∫sdt is an integral of s over the time.

In the more preferred embodiments, the impact kinetic energy of the drop hammer on the track is limited to the range of 186.13 J to 201.13 J.

The impact kinetic energy of the drop hammer on the track to be tested is calculated using the following formula:

$${E}_{k} = \frac{{( {\int }_{{t}_{b}}^{{t}_{e}} F ( t ) dt )}^{2}}{m}$$

In the formula, Eₖ is the impact energy, t is the duration of the impact, F(t) is the impact force, tₑ and t_{b} are respectively the start time and end time of the impact, and m is the mass of the drop hammer.

### Embodiment 5

A system for evaluating stiffness of railway ballasted tracks, includes:
a load-displacement curve module configured to draw a load-displacement curve of a standard ballast bed block according to inputted stiffness test data of the standard ballast bed block obtained from an indoor test;
function fitting module configured to acquire the load-displacement curve and fit a relationship function between the stiffness of the standard ballast bed block and test scalar;
standard establishing module configured to use the relationship function to obtain a stiffness evaluation standard based on the test scalar;
input module configured to input drop-weight test results for a track to be tested;
evaluation module configured to calculate the test scalar according to the drop-weight test results and evaluate stiffness conditions of the track to be tested; and
output module configured to output evaluation results.

### Embodiment 6

A computer-readable medium includes a computer program stored therein. When executed by a processor, the computer program performs any method described in Embodiments 1 to 4.

In this embodiment, all or part of the methods described in the aforementioned embodiments is implemented. The computer program can be stored in the computer-readable medium. The computer program can be executed by a processor to perform the steps in the aforementioned method embodiments. The computer program includes computer program codes, object codes, executable files or other intermediate forms. The computer-readable medium may include any entity or device capable of carrying the computer program code, recording medium, USB flash drive, mobile hard disk, magnetic disk, optical disk, computer memory, read-only memory (ROM), random access memory (RAM), electrical carrier signal, telecommunication signal and software distribution medium. It should be noted that the contents contained in the computer-readable medium may be appropriately added or reduced according to the requirements of legislation and patent practices within the jurisdiction.

The processor may be a central processing unit, and may also be other general-purpose processors, digital signal processors, application-specific integrated circuits, field-programmable gate arrays or other programmable logic devices, discrete gates or transistor logic devices, and discrete hardware components, etc.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

It should be noted that terms such as “including,” “comprising,” or any other variations thereof are intended to encompass non-exclusive inclusions, thereby allowing processes, methods, items, or devices that include a range of elements to not only include those elements but also other elements not explicitly listed or inherent to such processes, methods, items, or devices.

What is claimed is:

1. A method for evaluating stiffness of railway ballasted tracks, comprising steps of:
performing an indoor test to measure stiffness of a standard ballast bed block and plotting a load-displacement curve of the standard ballast bed block;
fitting, based on the load-displacement curve, a relationship function between the stiffness of the standard ballast bed block and test scalar;
using the relationship function to obtain a stiffness evaluation standard based on the test scalar;
conducting a drop-weight test on a track and calculating an actual test scalar of the track based on results of the drop-weight test; and
evaluating stiffness conditions of the track based on the actual test scalar of the track and the stiffness evaluation standard.

2. The method of claim 1, wherein the standard ballast bed block is a polyurethane-cured ballast bed block.

3. The method of claim 1, wherein the relationship function is fitted by steps of:
selecting three characteristic points on the load-displacement curve and calculating tangent slope of the load-displacement curve at each of the three characteristic points; and
using a cubic function to fit the tangent slope, with the test scalar as an independent variable and the stiffness of the standard ballast bed block as a dependent variable, to obtain the relationship function.

4. The method of claim 3, wherein the three characteristic points are points on the load-displacement curve corresponding to loads being 25%, 50% and 75% of measured wheel-rail force on the track.

5. The method of claim 3, wherein the cubic function is: kᵣ=ak³+bk²+ck+d, where kᵣ is the stiffness of the standard ballast bed block, k is the test scalar, and a, b, c, d are calibration coefficients.

6. The method of claim 1, wherein the stiffness evaluation standard based on the test scalar is obtained by steps of:
establishing a local track spring constitutive model and obtaining a dynamic displacement calculation formula comprising a plurality of variables;
conducting a plurality of on-site stiffness tests on a ballast bed by using standard testing methods to obtain values of the variables;
determining critical conditions for dynamic displacement;
obtaining ballast bed stiffness under the critical conditions by substituting the values of the variables and the critical conditions into the dynamic displacement calculation formula;
obtaining the test scalar under the critical conditions by substituting the ballast bed stiffness under the critical conditions into the relationship function; and
establishing the stiffness evaluation standard based on the test scalar according to the test scalar under the critical conditions.

7. The method of claim 1, wherein the step of calculating the actual test scalar of the track based on the results of the drop-weight test comprises steps of:
obtaining the results of the drop-weight test, wherein the results comprises impact force of a drop weight on the track, displacement of the track, and maximum displacement of the track during an impact process; and
substituting the results of the drop-weight test into a test scalar calculation formula to obtain the actual test scalar of the track.

8. The method of claim 7, wherein the test scalar calculation formula is established according to steps of:
assuming the track as a series-connected spring system, and establishing a balance equation between gravity of a drop hammer and elastic force of a spring, wherein the balance equation is defined as Equation 1;
establishing a momentum equation for a falling process of the drop hammer, integrating over time on both sides of the momentum equation to obtain Equation 2;
establishing an energy conservation equation of a process from a first moment at which the drop hammer starts to fall to a second moment at which the track reaches maximum displacement, wherein the energy conservation equation is defined as Equation 3; and
solving the Equation 1, Equation 2, and Equation 3 together to obtain the test scalar calculation formula.

9. The method of claim 7, the test scalar calculation formula is:
$$k = \frac{\begin{matrix}( 2 \int Fdt \int sdt + {{ms}_{0}}^{2} ) \pm \\ \sqrt{{( 2 \int Fdt \int sdt + {{ms}_{0}}^{2} )}^{2} - 4 {( \int sdt )}^{2} {( \int Fdt )}^{2}}\end{matrix}}{2 {( \int sdt )}^{2}}$$
where k is the test scalar, F is impact force of the drop weight on the track, s is the displacement of the track, s₀ is the maximum displacement of the track during the impact process, m is a mass of a drop hammer, t is time, ∫Fdt is an integral of F over the time, and ∫sdt is an integral of s over the time.

10. The method of claim 1, wherein in the drop-weight test, an impact kinetic energy of a drop hammer on the track ranges from 186.13 J to 201.13 J.
